(19) United States
(12) Patent Application Publication
(10) Pub. No.: US 2003/0208363 A1
(43) Pub. Date: Nov. 6, 2003

(54) Method of making mass solicitations and referrals

(76) Inventor: Erik Thurnher, Newport Beach, CA (US)

Correspondence Address: Michell P. Brook, Esq., Luce Forward Hamilton & Scripps LLP, Suite 200, 11988 El Camino Real, San Diego, CA, 92130, US

(21) Appl. No.: 10/241,092

(22) Filed: Sep. 10, 2002

Related U.S. Application Data
(60) Provisional application No. 60/377,944, filed on May 2, 2002.

(51) Int. Cl. G06F 17/60

(52) U.S. Cl. 705/1

(57) ABSTRACT

A method of making mass solicitations and referrals includes the steps of creating a network of financial advisors on behalf of a financial services network, obtaining a plurality of referrals for the financial advisors, providing the referrals to the group of financial advisors and providing specific disclosure information regarding the relationship between the financial advisors and the financial services network.

### RELATED APPLICATIONS

This application claims priority from U.S. Provisional Patent Application No. 60/377,944, which is incorporated herein by this reference in its entirety.

### FIELD OF THE INVENTION

The present invention relates to a method and apparatus involved in making mass solicitations and referrals.

### BACKGROUND OF THE INVENTION

There has been a need to provide verified referrals of independent financial advisors to consumers. For example, legislation now pending before Congress in 2002 may require employers who sponsor employee retirement plans to provide their employees with a source of fully independent financial advice. Specifically, Senate Bill 1971 “National Employee Saving and Trust Equity Guarantee Act” specifies that employers must provide a means for employees to have access to qualified investment advisors who are independent from the employer sponsored retirement plan.

Even absent such legislation, many employers may desire to ensure that their employees have an independent source of professional guidance for making decisions about the investment and distribution of funds in company sponsored retirement plans. Some such employers may have multiple facilities at geographically spread locations as well. Therefore, there exists a need for a method for providing employers with a cost-effective, reliable, and automated means for providing large numbers of employees, located in varying geographic areas, with access to multiple independent financial advisors.

In the financial services industry, solicitors often act as an intermediary between individuals that are seeking financial advice and independent advisors capable of providing such advice. A solicitor-based approach to making referrals provides a way to enable individuals or groups of individuals to gain access to independent financial advisors who have been organized for such purposes by the solicitor.

One way in which solicitors can be compensated is by receiving a share of the revenue derived from services provided by the advisor to whom a referral was made. Individuals or firms acting as solicitors in the financial services field are regulated under Rule 206(4)-3 of the Investment Advisers Act of 1940 (the “Solicitor's Rule”). Among other things, the Solicitor's Rule requires that solicitors provide, at the time of solicitation, certain disclosure documentation to each person being referred to an advisor with whom the solicitor has a business relationship.

There exists a need for a system and method of enabling solicitors in the financial services industry to make mass referrals of individuals, who may be located in widely dispersed geographic areas, on behalf of independent financial services providers in a manner that is compliant with the Solicitor's Rule.

### SUMMARY OF THE INVENTION

The present invention alleviates to a great extent the disadvantages of known referral systems and methods by providing a cost-effective, reliable, and automated system providing large numbers of persons, optionally located in geographically dispersed locations, referrals to multiple independent advisors. The present invention also provides solicitors, acting as intermediaries in the financial services industry, with a system of making mass referrals on behalf of the multiple independent advisors.

According to an embodiment of the present invention, a method of making mass solicitations and referrals includes the steps of creating a solicitor-based referral network by selecting a group of financial advisors, obtaining a plurality of referrals, providing the referrals to the group of financial advisors and providing the referrals with web-based access to the group of financial advisors. The present invention also includes a method of making automated mass referrals of large numbers of individuals who may be widely geographically dispersed to independent financial advisors who have been organized into a referral network by a solicitor, including steps of creating a solicitor-based referral network by selecting a group of financial advisors, obtaining a plurality of referrals, providing the referrals to the group of financial advisors and providing the referrals with web-based access to the group of financial advisors.

Other embodiments of the present invention include a method of making mass referrals using a financial services network, wherein the method is implemented using a client system, server system and an electronic communication network, the client system running client software for managing the communications between the client system and the electronic communications network, the server system running server software for managing communications between a plurality of client systems and the electronic communications network, and the server system in electronic communication with a plurality of access ports, the method including the steps of creating a network of financial advisors on behalf of a financial services network, obtaining a plurality of referrals for the financial advisors, providing the referrals to the group of financial advisors and providing specific disclosure information regarding the relationship between the financial advisors and the financial services network.

Additional embodiments include an apparatus for making mass referral for use by a financial services network, wherein the apparatus is implemented using a client system, server system and an electronic communication network, the client system running client software for managing the communications between the client system and the electronic communications network, the server system running server software for managing communications between a plurality of client systems and the electronic communications network, and the server system in electronic communication with a plurality of access ports, the apparatus including means for creating a network of financial advisors on behalf of a financial services network, means for obtaining a plurality of referrals for the financial advisors, means for providing the referrals to the group of financial advisors and means for providing specific disclosure information regarding the relationship between the financial advisors and the financial services network.

Still other embodiments include a data storage medium including machine readable code thereon for use in a client computer system having a communications interface and means for reading code from the storage medium, the storage medium including means for creating a network of financial advisors on behalf of a financial services network, means for obtaining a plurality of referrals for the financial advisors, means for providing the referrals to the group of financial advisors and means for providing specific disclosure information regarding the relationship between the financial advisors and the financial services network.

These and other features and advantages of the present invention will be appreciated from review of the following detailed description of the invention, along with the accompanying figures in which like reference numerals refer to like parts throughout.

### BRIEF DESCRIPTION OF THE DRAWINGS

FIG. 1 is a flowchart illustrating some embodiments of the present invention;

FIG. 2 is a flowchart illustrating some embodiments of the present invention;

FIG. 3 is a flowchart illustrating some embodiments of the present invention;

FIG. 4 is a flowchart illustrating some embodiments of the present invention;

FIG. 5 is a diagram illustrating some embodiments of the present invention; and

FIG. 6 is a diagram illustrating some embodiments of the present invention.

### DETAILED DESCRIPTION OF THE INVENTION

In accordance with the present invention, systems for and methods of making mass referrals are provided. In some embodiments, means are provided for establishing access to an electronic communications network using a client system that may be a desktop computer, work station, or any other type of computer or electronic communication system, whether stationary, mobile or portable.

According to the present invention, “electronic communications network” or “ECN” includes any computing, multimedia or video system that a user can remotely access. Examples of ECNs include on-line services, dial up computer servers, wide area networks, e-mail systems and the Internet. According to the present invention, “client system” includes any device used for access an ECN, typically a data processing system. Such devices may include personal computers, Internet stations, palm computers, hand-held computers and portable computers.

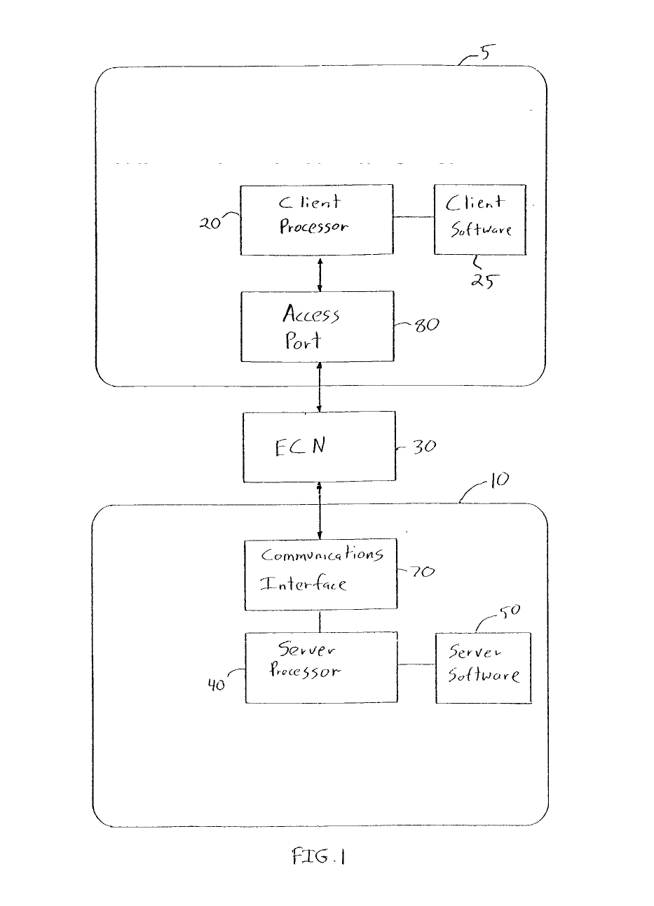

FIG. 1 is a block diagram showing a client system 5 and a server system 10 according to an embodiment of the present invention. During use, client system 5 connects to the server system 10 via an ECN 30. Client system 5 includes client processor 20 and server system 10 includes a server processor 40. Processor 40 operates various software, including server software 50 for managing communications between a plurality of client systems 5 and the ECN 30. The client system 5 runs client software 25 for managing the communications between the client system 5 and the ECN 30. Examples of the client software may include general purpose internet access software, such as available from America Online, Earthlink, MSN etc., or browser software, such as Internet Explorer from Microsoft or Netscape Communicator from Netscape, or a specialized access software for direct dial-up or alternatively for use on the ECN, whether for access directly or in conjunction with other software, such as a “plug in”.

In operation, the ECN 30 acts as in interface between the client system 5 and the server system 10. According to some embodiments, the server system 10 includes a communications interface 70 for communication with the ECN 30. The ECN 30 communicates with the client system 5 via access port 80.

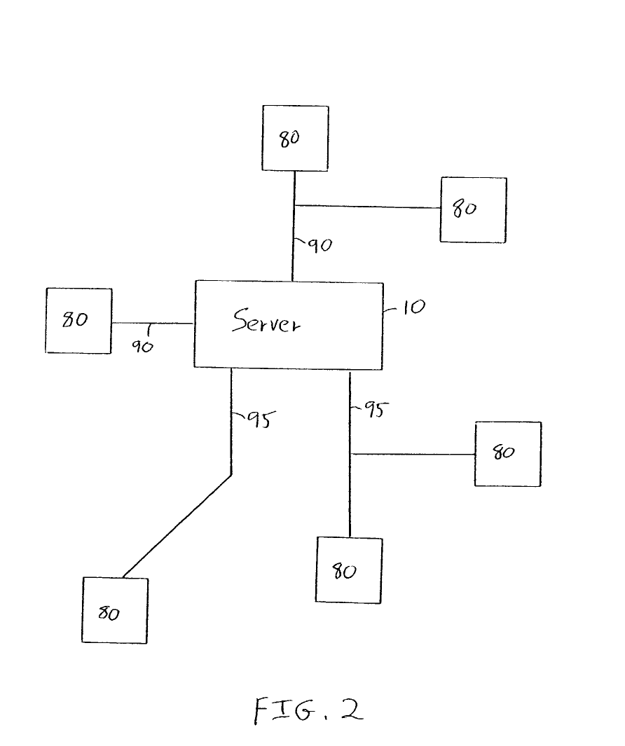

As seen in FIG. 2, according to some embodiments, server 10 is a communications station 10 providing access to the ECN 30. Access ports 80 are distributed and linked via wires 90 to the communications station 10. Alternatively, the access ports 80 are linked via wireless communication (illustrated as lines 95), in which the access port 80 is equipped with a wireless transmitter and the server 10 is equipped with a wireless receiver.

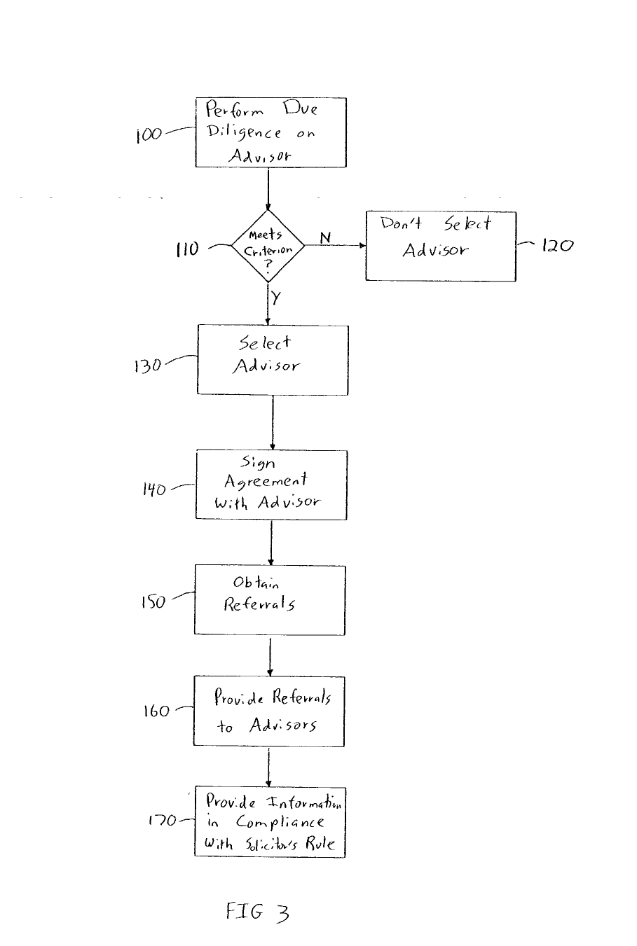

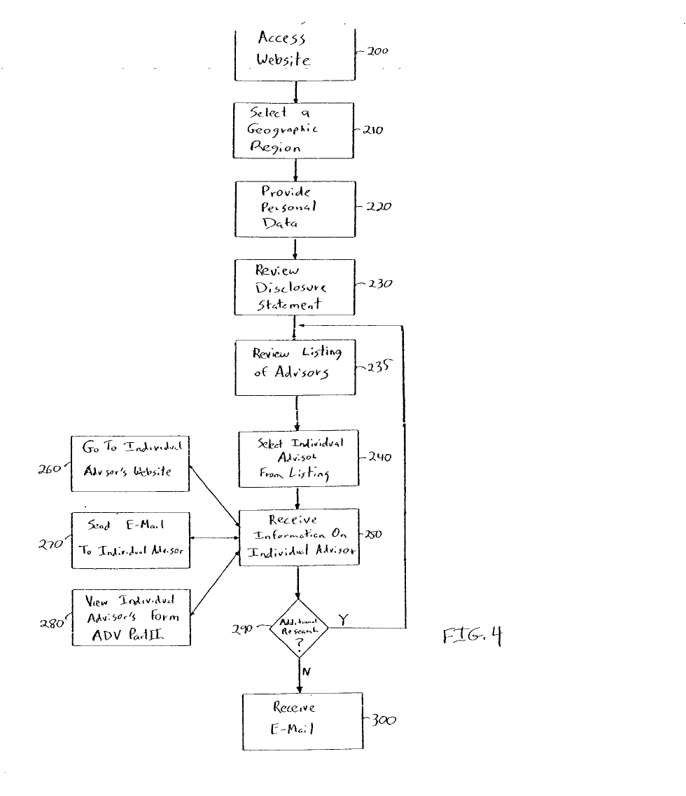

FIGS. 3 and 4 show a mass referral system including a novel business and technology model concerning the solicitation of referrals for independent providers of financial services. This model provides employers with a cost-effective, reliable, and automated means for providing large numbers of employees with access to multiple independent financial advisors. Moreover, the model provides solicitors in the financial services industry the means to make mass solicitations for referrals on behalf of independent financial services providers in a manner that is fully compliant with the Solicitor's Rule.

As seen in FIG. 3, according to an embodiment of the present invention, the business and technology model works in the following manner. The solicitor creates a referral network of independent financial services providers (the “financial services network”) by first performing due diligence (step 100) on independent financial advisors in a given geographic area. The due diligence process (step 100) is conducted for the purpose of identifying advisors that meet criteria, such as, for example criteria of competence, service, experience, ethics, regulatory compliance, and method of compensation.

According to an exemplary embodiment of selection criteria, to ensure independence, candidate advisors can operate as separate businesses without a proprietary set of financial products, and may utilize a “fee-only” method of compensation. In the “fee-only” method of compensation, the advisor is paid by the client, and by the client only, for providing any financial products or services. At step 110, a question is presented as to whether an advisor meets these strict criteria. If the answer is “no”, the advisor is not selected (step 120). If the answer is “yes”, the advisor is selected (step 130) and a contract is negotiated.

Once the financial services network has selected an independent advisor (step 130) to participate in the network, the financial services network and the advisor sign an agreement (step 140), which provides that the financial services network will receive a share of any revenue generated from referrals provided to the advisor by the financial services network. The agreement signed by both parties conforms to the relevant requirements of the Solicitor's Rule.

According to an agreement between the financial services network and each of its advisors, an advisor shall remit a client referral fee to the financial services network on a quarterly basis for each client referred to the advisor by the financial services network for whom investment management services are being provided by the independent financial advisor to the referral. The applicable financial services network client referral fee rate is a function of the value as of the last day of the preceding calendar quarter of the aggregate assets under management (AUM) by the advisor for all clients referred to the advisor by the financial services network, and is calculated as a single rate applicable to all client accounts. Advisors are contractually obligated not to charge referrals any additional costs to recover payments made to the financial services network.

In order to provide the financial services network with the ability to monitor the aggregate amount of assets under management by the independent financial advisors on behalf referrals provided by the financial services network, the independent financial advisor grants the financial services network, as part of the agreement between the two entities, the ability to view the investment accounts of referrals via the Internet. This allows the financial services network to cross-check the amount of the client referral fee payments made to it by the independent financial advisor. The sharing of client account data is fully disclosed to referrals by both the financial services network and the independent financial advisor through their respective privacy policies.

In step 150, the financial services network obtains a plurality of referrals. This can be accomplished through a number of methods, but is primarily made to occur through the negotiation service agreements with employers that want, or need, to make available to their employees independent financial advice. Private individuals not associated with an employer can also access the financial services network to obtain a referral to a provider of independent financial advice.

The next step (step 160) is to provide a method for the financial services network, to refer individuals, or groups of individuals, who are seeking independent financial advice, and who may exist in very large numbers and be dispersed over wide geographic areas, to the independent financial services providers who participate in the financial services network. Because the financial services network is acting as solicitor in the financial services industry, under current regulations, specific information must be provided in compliance with the requirements of the Solicitor's Rule (step 170).

The Solicitor's Rule was drafted by the Federal Government to ensure full and timely disclosure of germane aspects of the business relationship between the solicitor and the financial advisor for whom the solicitor is soliciting referrals. The required disclosures, and the timing of their delivery, are intended to ensure that consumers who have been referred to a financial services provider by a solicitor, can make informed decisions about whether to engage the financial services provider. The Solicitor's Rule requires that the solicitor provide information (step 170) to each individual referred to an advisor with whom the solicitor has a business relationship, and receives compensation. The information includes a stand alone Disclosure Statement and a copy of the advisor's Form ADV Part II, or its equivalent in brochure form. It should be noted that the guidelines provided by the Solicitor's Rules are provided here as just one example of the set of information that can be used and provided in the mass referral system. However, any set of information can be provided to allow selection among service providers. Service providers may relate to any type of business and may include accountants, attorneys, marketers, car dealerships, retailers, opticians, physicians, etc.

The Disclosure Statement provides information regarding germane elements of the business relationship between the solicitor and participating advisors. Section (b) of the Solicitors Rule requires that the Disclosure Statement must contain the following specific information:

(1) The name of the solicitor;

(2) The name of the investment adviser;

(3) The nature of the relationship, including any affiliation, between the solicitor and the investment adviser;

(4) A statement that the solicitor will be compensated for his solicitation services by the investment adviser;

(5) The terms of such compensation arrangement, including a description of the compensation paid or to be paid to the solicitor; and

(6) The amount, if any, client will be charged beyond the advisor's usual fees.

Form ADV Part II is a multi-page disclosure document, which contains information on the advisor's personal, and business background and business methods, and is derived from registration documentation provided each year to the Securities and Exchange Commission or State Department of Corporations, by the Advisor. An equivalent brochure, containing essentially the same information as exists in Form ADV Part II may also be used.

The Solicitor's Rule also contains specific requirements as to the timing of the delivery of the Disclosure Statement and Form ADV Part II, or its equivalent. Section (a)(2)(iii) of the Solicitor's Rule requires that both of the required disclosure documents must be provided to the person being solicited (the “referral”) “at the time of any solicitation activities”.

For solicitor's who are working with one referral or a limited number of referrals at any given time, this requirement is not difficult to comply with. The disclosure documents are generally delivered in person at the time the referral is made. However, for a solicitor that desires to bring together referrals and advisors on a mass basis, or in that instance where the referrals and advisors are widely geographically dispersed, the Solicitor's Rule creates a substantial operational hurdle. Since the disclosure documents must be provided at the time the referral is made, it is difficult or impossible to make large numbers of referrals, or referrals of individuals who are widely geographically dispersed, and remain in compliance with the requirements of the Solicitor's Rule.

The financial services network is the first solicitor firm to develop a business and technological model to solve this problem. The financial services network has created an automated, Internet-based approach to making referrals on a mass basis, across wide geographic areas, which allows the solicitor to remain in full compliance with the Solicitor's Rule.

A mass referral website according to some embodiments of the present invention will now be described. After the financial services network signs an agreement with an independent financial advisor for inclusion of the advisor in the solicitor's referral network, the advisor's contact information is placed in digital format on the financial services network's website (www.medcentriconline.com) where it may be accessed using the website's “referral engine”. This referral engine was conceived, designed, and implemented by the financial services network as a means to provide a fully automated, web-based solution for making mass referrals of geographically dispersed individuals seeking financial advice from independent financial advisors, in a manner that is fully compliant with the requirements of the Solicitor's Rule.

The employees or other individuals seeking independent financial advice are directed to the financial services network's website where they can access the “Find an Adviser” referral engine. “Find an Advisor” is a unique, specialized, multi-function referral engine that, according to some embodiments, combines the following elements:

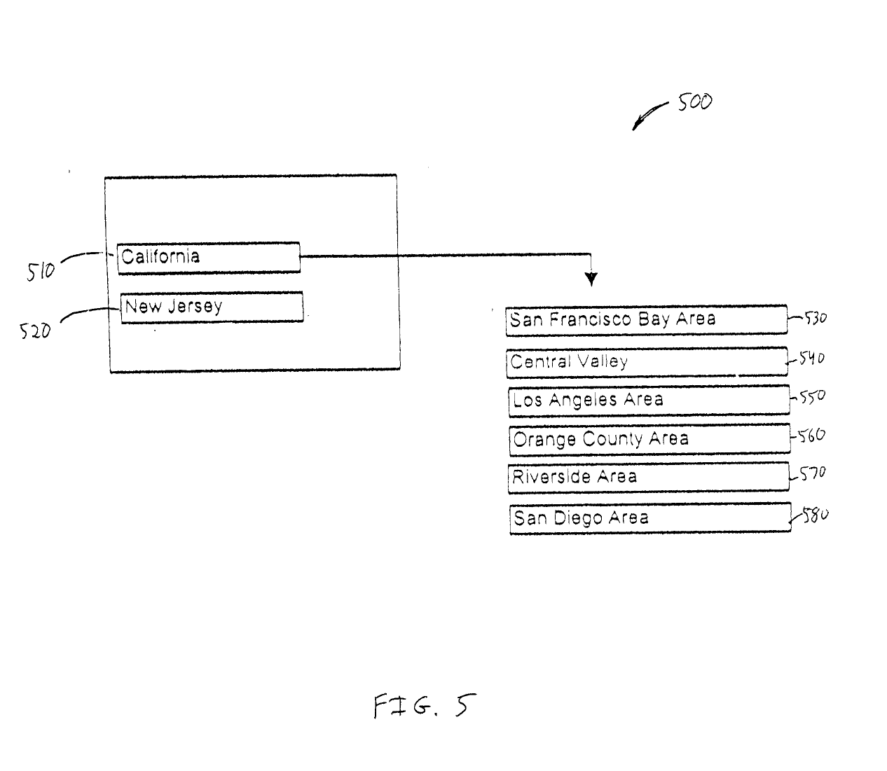

1.) A geographic area selection menu 500, as shown in FIG. 5;

2.) A set of data collection fields for each visitor using the site to obtain a referral;

3.) Embedded disclosure documents including a.) a stand alone Disclosure Statement, and b.) Form ADV Part II disclosure document or its equivalent for each participating advisor;

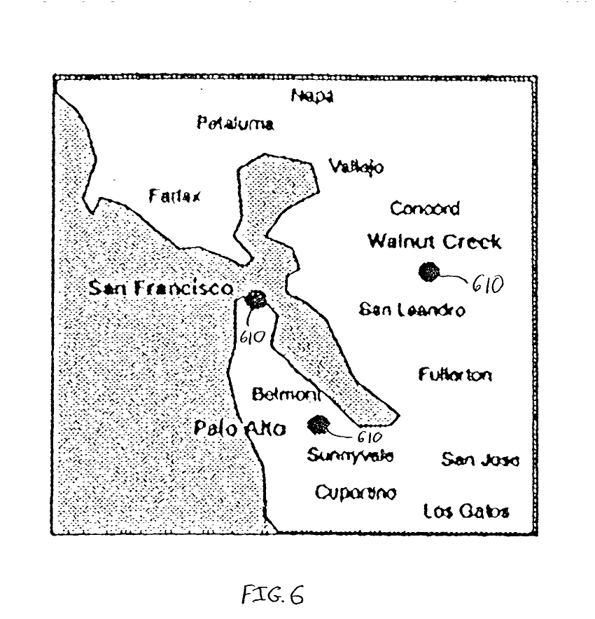

4.) Geographic maps (as an example, a San Francisco area map 600 is shown in FIG. 6) containing markers 610 representing individual advisors participating in the financial services network;

5.) Advisor information pages which provide the following data; a.) personal and business background information on the advisor b.) contact information for the advisor c.) a photograph or logo of the advisor d.) a means for the referral to send an email requesting contact directly to the advisor e.) a link to the advisor's website f.) the advisor's Form ADV Part II or its equivalent;

6.) A database which complies and cross-correlates data collected from visitors who entered their personal and professional data into the referral engine's data collection fields, with each advisor for whom the referral requested data by visiting the advisor's information page; and

7.) An automatic e-mail generator linked to the database, which sends to each referral an email containing links to the stand alone Disclosure Statement and the Form ADV Part II for each advisor whose information page the referral viewed. The Disclosure Statement and Form ADV Part II are provided in PDF format so that they may be view, printed, or downloaded.

The above elements function together to provide a method to allow large numbers of geographically dispersed individuals to research and obtain referrals to independent financial advisors who have been organized by a solicitor into a referral network, in a fully automated manner, while ensuring compliance with the Solicitor's Rule by providing required disclosure documentation through both embedded documents and a unique database and email based system.

The financial services networks combines it business and technology model as follows. After creating a solicitor based financial services network, as described in above, the solicitor directs employees or other individuals seeking independent financial advice to the financial services network's website where they can access the “Find an Adviser” referral engine.

As seen in FIG. 4, according to an embodiment of the present invention, the following method for using the financial services network's website is provided. In step 200, an individual seeking a financial advisor accesses the financial services network's website. To use the referral engine, each visitor to the website must first select a geographic region (step 210) in which they would like to obtain a referral to a participating advisor or advisors.

As best seen in FIG. 5, the visitor has a choice of states including California 510 and New Jersey 520. Should the visitor click on California 510, an additional menu pops up prompting the visitor to click on an appropriate California region. In this embodiment, the regions include San Francisco Bay Area 530, Central Valley 540, Los Angeles Area 550, Orange County Area 560, Riverside Area 570 and San Diego Area 580.

The website visitor is subsequently asked to provide personal data (step 220) about themselves, including their full name, title, address, work phone number, employer name, and an e-mail address. After completing this page, the visitor is directed to another web page which includes the financial services network Disclosure Statement in scroll box format. The visitor is asked to review the Disclosure Statement (step 230), which outlines the business relationship between the financial services network and the advisor. By embedding this step into the required functional flow of the referral engine, the financial services network ensures that each person using the referral engine receives the Disclosure Statement required under the Solicitor's Rule.

The visitor is then directed to a map of the geographic region they selected. FIG. 6 depicts a map 600 of the San Francisco Area. On the map 600 are markers 610, each of which represents an advisor who participates in the financial services network. Visitors can review this listing of advisors (step 235) and select an individual advisor (step 240) by clicking on the appropriate marker 610. When the visitor clicks on a marker 610, they are taken to an advisor information page where they receive personal and business background information as well as contact information for that advisor (step 250).

The advisor information page also provides a link to the advisor's website (step 260), and contains a message function which allows the visitor to send an email message (step 270) directly to the advisor. Each advisor information page also contains a link to the advisor's Form ADV Part II or its equivalent in PDF format (step 280). The visitor may research additional advisors (step 290) by clicking on other markers. Each time that the visitor to the website views an advisor's information page, a record is made by the referral engine database.

When the visitor leaves the website, the email generator compiles a list of advisors whose information pages were viewed by the visitor as recorded by the website database. This list is then translated into a set of links to each advisor's Form ADV Part II, as well as to a copy of the Disclosure Statement. The links will allow the recipient to view or download the appropriate disclosure documents. In step 300, the email is sent to the visitor, thereby ensuring that each person using the referral engine has further access to the two disclosure documents which are also embedded in the functional flow of the website.

Should an invalid email address, or other problem beyond the control of the financial services network, prevent electronic transmission of the disclosure documents, then these documents may be sent via regular mail using the personal data of the referral as stored in the referral engine database.

According to some embodiments, the business and technology model is further enhanced by giving individuals seeking independent financial advisors the option of calling the financial services network using a phone number established for this purpose. In this instance, personnel of the financial services network verbally collect substantially from each individual seeking an independent financial advisor, the same data as is collected from referrals by the referral engine on the financial services network website.

The financial services personnel then utilize the referral engine, or a proprietary equivalent of the referral engine, in real time to obtain information on advisors in the area requested by the individual seeking the referral, and relay that information verbally to the individual. Disclosure information related to the stand-alone Disclosure Statement may be provided verbally by the financial services network personnel as well. After the individual has been referred by the financial services network personnel, the email generator, or its proprietary equivalent, will electronically transmit the necessary disclosure documents, including Form ADV Part II for each advisor for whom information was provided to the individual.

Thus, it is seen that a method of making automated, mass referrals through an Internet based referral engine is provided. One skilled in the art will appreciate that the present invention can be practiced by other than the preferred embodiments which are presented in this description for purposes of illustration and not of limitation, and the present invention is limited only by the claims that follow. It is noted that equivalents for the particular embodiments discussed in this description may practice the invention as well.

What is claimed is:

1. A method of making mass referrals, comprising the steps of:
selecting a group of financial advisors;
obtaining a plurality of referrals;
providing the referrals to the group of financial advisors; and
providing the referrals with web-based access to the group of financial advisors.

2. The method of claim 1, wherein the step of providing the referrals with web-based access to the group of financial advisors includes the step of providing the referrals with information regarding the financial advisors in compliance with the Solicitor's Rule.

3. A method of linking people seeking financial advice with pre-screened independent financial advisors, comprising the steps of:
selecting a group of financial advisors;
obtaining a plurality of referrals;
providing the referrals to the group of financial advisors; and
providing the referrals with web-based access to the group of financial advisors, wherein the referrals can research multiple advisors before selecting a single advisor.

4. The method of claim 3, wherein the step of providing the referrals with web-based access to the group of financial advisors includes the step of providing a web-based map having markings, wherein a marking indicates the presence of an advisor within a certain geographic region.

5. A method of making mass referral for use by a financial services network, wherein the method is implemented using a client system, server system and an electronic communication network, the client system running client software for managing the communications between the client system and the electronic communications network, the server system running server software for managing communications between a plurality of client systems and the electronic communications network, and the server system in electronic communication with a plurality of access ports, the method comprising the steps of:
creating a network of financial advisors on behalf of a financial services network;
obtaining a plurality of referrals for the financial advisors;
providing the referrals to the group of financial advisors; and
providing specific disclosure information regarding the relationship between the financial advisors and the financial services network.

6. The method of claim 5, wherein the step of providing specific disclosure information includes the step of providing information concerning the individual advisor's ADV Part II.

7. The method of claim 5, wherein the step of providing specific disclosure information includes the step of providing access to a financial services network website.

8. The method of claim 7, wherein the step of providing access to a financial services network website includes the step of providing access to information concerning the individual referrals.

9. The method of claim 8, wherein the step of providing access to a financial services network website further includes the step of providing information in compliance with the Solicitor's Rule.

10. The method of claim 5, wherein the step of creating a network of financial advisors includes the step of identifying independent financial advisors that meet specific criteria.

11. A method of using a financial service network website linking a plurality of referrals with a network of financial advisors, including the steps of:
selecting an appropriate geographic region;
reviewing a Disclosure Statement;
selecting an individual advisor from the network of financial advisors; and
automatically receiving a communication concerning the individual advisor.

12. The method of claim 11, further including the step of providing personal data when prompted by the website.

13. The method of claim 11, wherein the step of reviewing the Disclosure Statement includes the step of reviewing an outline of the business relationship between the advisor and the financial services network.

14. The method of claim 11, wherein the step of selecting an individual advisor from the network of financial advisors includes the step of clicking on an appropriate marker.

15. The method of claim 1, further including the step of receiving background information concerning the individual advisor.

16. The method of claim 11, further including the step of sending a direct e-mail message to the advisor.

17. The method of claim 11, further including the step of accessing a link to the advisor's website.

18. The method of claim 11, further including the step of accessing a direct link to the advisor's form ADV Part II.

19. The method of claim 11, wherein the step of automatically receiving a communication concerning the individual advisor includes the step of receiving a communication concerning the individual advisor's ADV Part II as well as a copy of the Disclosure Statement.

20. The method of claim 11, further including the step of researching additional advisors.

21. An apparatus for making mass referral for use by a financial services network, wherein the apparatus is implemented using a client system, server system and an electronic communication network, the client system running client software for managing the communications between the client system and the electronic communications network, the server system running server software for managing communications between a plurality of client systems and the electronic communications network, and the server system in electronic communication with a plurality of access ports, the apparatus comprising:
means for creating a network of financial advisors on behalf of a financial services network;
means for obtaining a plurality of referrals for the financial advisors;
means for providing the referrals to the group of financial advisors; and
means for providing specific disclosure information regarding the relationship between the financial advisors and the financial services network.

22. A data storage medium including machine readable code thereon for use in a client computer system having a communications interface and means for reading code from the storage medium, the storage medium comprising:
means for creating a network of financial advisors on behalf of a financial services network;
means for obtaining a plurality of referrals for the financial advisors;
means for providing the referrals to the group of financial advisors, and
means for providing specific disclosure information regarding the relationship between the financial advisors and the financial services network.
